(19) United States
(12) Patent Application Publication
(10) Pub. No.: US 2024/0313499 A1
(43) Pub. Date: Sep. 19, 2024

(54) Pulsed Laser System

(71) Applicant: Allegro MicroSystems, LLC, Manchester, NH (US)

(72) Inventors: Michael James Munroe, Portland, OR (US); Paul Hoffman, Hood River, OR (US); Archie Barter, Beaverton, OR (US)

(73) Assignee: Allegro MicroSystems, LLC, Manchester, NH (US)

(21) Appl. No.: 18/184,242

(22) Filed: Mar. 15, 2023

(51) Int. Cl. H01S 3/113; G01S 7/484; H01S 3/00; H01S 3/091; H01S 3/094; H01S 3/0941; H01S 3/102; H01S 3/108; H01S 3/16

(52) U.S. Cl. CPC H01S 3/113; G01S 7/484; H01S 3/0071; H01S 3/0912; H01S 3/094076; H01S 3/0941; H01S 3/1024; H01S 3/1083; H01S 3/1608; H01S 3/1611; H01S 3/1618; H01S 3/1643; H01S 3/1666; H01S 3/1673; H01S 2302/00

(57) ABSTRACT

Systems, methods, and circuits provide passively Q-switched laser systems operable to emit a pulse train that is synchronized to a reference clock operating at a relatively high pulse repetition frequency. Such pulsed laser systems can include a gain medium; a pump source that excites the gain medium into a higher energy state; a passive Q-switch; a photodetector that produces an electronic signal synchronous with the laser output pulse; and an electronic control system that inputs the signal from the photodetector and controls the pump source to optimize the synchronization between the output laser pulses and a reference clock. The clock source may be internally generated by the electronic control system or input externally. In some examples and embodiments, passively Q-switched lasers can be utilized as transmitters in automotive LIDAR systems.

### BACKGROUND

As is known in the art, lidar imaging systems periodically illuminate target areas or regions with optical energy and detect reflected energy (“returns”) in a defined field-of-view (FOV). Lidar systems can use a single laser or multiple lasers to transmit pulses, and single or multiple detectors for sensing and timing the pulse returns. A lidar system's FOV is the portion of the scene that its detectors can sense in a single observation. Lidar systems typically continuously refresh time or range data about the FOV.

Lidar imaging systems typically determine range to objects by measuring the round-trip travel time of an optical pulse. This measurement is accomplished with an active pulse detection circuit, or multiple active pulse detections circuits arranged in parallel. The pulse detection time is measured with a time measurement system often including a clocked counter and sometimes a fractional-clock counter.

So-called Q-switching is a known way to generate high peak-power output pulses from laser systems. An optical cavity's quality factor “Q” is a dimensionless parameter often defined as the ratio of the energy stored in the cavity to the energy lost. In a Q-switched laser, the laser's Q value starts out low enough such that the laser is below the oscillation threshold and the gain medium becomes excited by the absorbed pump energy. The Q value then increases (switches) causing the laser to become above oscillation threshold and a short pulse builds up in the cavity and sweeps the energy out of the excited gain medium. The most common method of changing the cavity Q is by changing the optical loss of the cavity.

A laser resonator is typically made up of two mirrors that are on either side, along the optical path, of the laser gain medium (e.g., crystal) and Q-switch. Initially the losses are high when the Q-switch is in the “off” state keeping the laser below oscillating threshold (losses high) and the gain (excited state population) in the laser crystal increases. During this period the gain increases with time, but negligible optical power builds up in the cavity. The Q-switch is then switched to the “on” state decreasing the cavity loss to a point where the laser is above oscillating threshold, i.e., the gain is greater than the losses. During this period a pulse quickly builds up sweeping out most of the energy stored in the laser gain medium (e.g., solid state crystal) and is emitted out of the laser through the partially reflecting cavity mirror. After the pulse is emitted the Q-switch transitions back into the “off” state and the cycle can repeat itself.

Q-switches can be categorized as either active or passive. In active Q-switching, an active switching element modulates the resonator losses periodically between a high value and a low value. Factors such as the pulse repetition rate can be controlled by the modulator and the pulse energy and duration are dictated by the energy stored by the gain medium. The Q losses are modulated by some externally controlled (active) element, usually an acousto-optic or electro-optic modulator using an electrically-controlled signal, but there are also mechanically controlled Q-switches, e.g., based on rotating mirrors. Optical switching is also possible.

Q-switching can also be achieved passively, through the insertion of a saturable absorbing medium, e.g., configured as a saturable absorber (SA) optical element, into the optical cavity. Population inversion in the gain medium is built up by the pumping process until the gain inside the cavity exceeds the absorption of the saturable absorbing medium. When the laser intensity approaches the saturation intensity of the saturable absorber, the absorber begins to bleach and the growth rate of the laser intensity is increased, resulting in more rapid bleaching of the absorber. The gain of the laser then greatly exceeds the losses introduced and a pulse is emitted. Passive Q-switching has the advantage of a simpler laser system with less electronic controls and a lower part count.

A limitation of prior art passive Q-switching techniques using saturable absorbers has been an inability to synchronize the output at high pulse repetition frequencies (PRF), where high PRF is defined as the pulse period being on the order of, or less than, the excited state lifetime of the laser gain medium. In high PRF operation, there is significant excited state population maintained in the gain medium between pulses. This causes a slow variation in the excited state population that results in pulses being emitted at different times, double pulsing, and missed pulsing. Another limitation of prior art techniques using saturable absorbers has been found for co-doped gain media. When pumping co-doped gain material, e.g., Ytterbium/Erbium doped Yttrium Aluminum Borate (YAB), one dopant (e.g., Yb atoms) absorb the pump energy then transfer this energy to the other dopant(s), e.g., Erbium atoms. This finite time required by this energy transfer results in the gain medium being pumped immediately after the pulse even though the pump has already been turned off, negatively affecting time of the pulses.

### SUMMARY

One general aspect of the present disclosure includes a passive Q-switched synchronous laser. The passive Q-switched synchronous laser system can include an optical cavity having an optical axis; a gain medium disposed in the optical cavity along the optical axis; pump means configured to supply the gain medium with pump energy; a passive Q-switch disposed in the optical cavity along the optical axis, where the passive Q-switch switches the Q factor of the optical cavity from a low state to a high state, and where the optical cavity produces laser output pulses as a result of the passive Q-switch switching the q state of the optical cavity; a photodetector configured to detect the laser output pulses and to produce corresponding signals indicative of and synchronous with the laser output pulses; and control circuitry configured to receive the signals from the photodetector and control application of power to the pump means to synchronize the output laser pulses to a reference clock signal.

Implementations, examples, and embodiments may include one or more of the following features. The passive Q-switch laser system can be configured to produce the laser output pulses as an output pulse train having a pulse repetition frequency (PRF). The control circuitry may include a feedback loop with an error signal based on the frequency and phase difference between the output pulse train and the reference clock signal. The passive Q-switch may include a saturable absorber. The saturable absorber may include chromium-doped yttrium-aluminum-garnet (Cr₄₊:YAG). The saturable absorber may include cobalt-doped spinel (Co₂₊:MgAl2O4). The saturable absorber may include vanadate-doped yttrium-aluminum-garnet (V₃₊:YAG). The system/laser may include an optical parametric oscillator (OPO) configured to shift the laser output in wavelength. The active medium may include erbium-ytterbium-doped yttrium aluminum borate (Er, Yb:YAB). The active medium may include neodymium doped yttrium vanadate (Nd:YVO4). The active medium may include neodymium doped yttrium aluminum garnet (Nd:YAG). The active medium may include erbium-ytterbium-doped yttrium aluminum garnet (Er:YAG). The active medium may include erbium-ytterbium-doped yttrium aluminum garnet (Er, Yb:YAG). The gain medium may include a crystal or glass matrix doped with rare earth ions. The laser can be operative to produce laser output pulses having a wavelength of between about 800 nm and about 1800 nm. The laser output pulses have a wavelength of between about 900 nm to about 910 nm. The laser output pulses may have a wavelength of between about 1300 nm to about 1700 nm. The laser output pulses may have a wavelength of between about 1500 nm and about 1650 nm. The laser output pulses may have a wavelength of between about 1515 nm and 1560 nm. The laser output pulses may have a wavelength of about 1522 nm. The laser output pulses may have a pulse repetition frequency (PRF) of about 200 kHz to about 500 kHz. The laser output pulses may have a wavelength of about 1064 nm. The one or more laser diodes may include one or more laser diodes configured to produce an output having a wavelength of about 970 nm to about 980 nm. In some embodiments/examples, the laser output pulses have a PRF of about 10 kHz to about 500 kHz. The pump means may include one or more laser diodes. The control circuitry may be configured to produce a controlled signal to the pump that is characterized by a frequency nominally equal to the desired laser PRF of the pump laser, a phase, a duty-cycle, and a dc value. The control circuitry may include a switching power supply where the switching frequency of the power supply modulates the pump drive. The control circuitry may include a power supply where modulation of the control voltage of the power supply determines the frequency, phase, duty cycle, and dc value of the pump drive current.

One general aspect includes an illumination system for scanned lidar (ladar). The illumination system can include a laser system operative to produce a laser output, the laser system may include; an optical cavity having an optical axis; a gain medium disposed in the optical cavity along the optical axis; pump means configured to supply the gain medium with pump energy; a passive Q-switch disposed in the optical cavity, where the passive Q-switch is configured to absorb optical energy received from the gain medium up to a threshold and then to transmit the optical energy once the threshold has been exceeded, where the passive Q-switch switches the Q factor of the optical cavity from a low state to a high state, and where the optical cavity produces laser output pulses as a result of the passive Q-switch switching the Q state (e.g., value of Q) of the optical cavity; a photodetector configured to detect the laser output pulses and to produce corresponding signals indicative of and synchronous with the laser output pulses; and control circuitry configured to receive the signals from the photodetector and control application of power to the pump means to synchronize the output laser pulses to a reference clock signal. The system may also include an optic operative to receive the laser output pulses and produce a beam output having an angular spread in a first direction; and a scanning system operative to scan the beam output across a desired angular span in a direction substantially orthogonal to the first direction.

Implementations, embodiments, and examples may include one or more of the following features. The illumination system where the passive q-switch is configured to produce the laser output pulses as an output pulse train having a pulse repetition frequency (PRF). The control circuitry may include a feedback loop with an error signal dependent on the frequency and phase difference between the output pulse train and the reference signal. The passive Q-switch may include a saturable absorber. The saturable absorber may include chromium-doped yttrium-aluminum-garnet (Cr₄₊:YAG). The saturable absorber may include cobalt-doped spinel (Co₂₊:MgAl2O4). The saturable absorber may include vanadium-doped yttrium-aluminum-garnet (V₃₊:YAG). The active medium may include a crystal or glass matrix doped with rare earth ions. The active medium may include erbium-ytterbium-doped yttrium aluminum borate (Er, Yb:YAB). The laser can be operative to produce laser output pulses having a wavelength of between about 800 nm and about 1800 nm. The laser output pulses may have a wavelength of between about 1300 nm and about 1650 nm. The laser output pulses may have a wavelength of between about 1515 nm and 1560 nm. The laser output pulses may have a PRF of about 50 kHz to about 500 kHz or higher. The scanning system may include a line scan system. The scanning system may include a point scan system.

Another general aspect of the present disclosure includes a method of controlling a Q-switched laser. The method can include providing an optical cavity having a gain medium disposed on an optical axis; providing pump means configured to supply the gain medium with pump energy; providing a passive Q-switch disposed in the optical cavity, where the passive Q-switch is configured to switch the quality (Q) factor of the optical cavity from a low state to a high state, and where the optical cavity is configured to produce laser output pulses configured as an output pulse train having a pulse repetition frequency (PRF) as a result of the passive Q-switch switching the Q state of the optical cavity; using a photodetector, detecting the laser output pulses and producing corresponding signals indicative of and synchronous with the laser output pulses; providing the corresponding signals from the photodetector to the control circuitry for controlling application of power to the pump means; using the control circuitry, providing a control signal to the pump means to adjust the pump energy supplied to the gain medium; and synchronizing the output laser pulses to a reference clock signal.

Implementations, embodiments, and examples may include one or more of the following features. The method may include providing the control circuitry with an error signal based on the frequency and phase difference between the output pulse train and the reference clock signal. The laser output pulses may have a PRF of about 50 kHz to about 500 kHz. The control signal can have a frequency nominally equal to the PRF.

Example embodiments can include a system of one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations of the described techniques, systems, and apparatus may include hardware, a method or process, or computer software on a computer-accessible medium.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram showing major components of an example embodiment of a lidar system utilizing a Q-switched laser, in accordance with the present disclosure;

FIG. 2 is a block diagram showing major functional components of an example passively Q-switched pulsed laser system, in accordance with the present disclosure;

FIG. 3 shows an example passively Q-switched diode-pumped solid state laser system, in accordance with the present disclosure;

FIG. 4 is a block diagram of an example laser control system/circuit, in accordance with the present disclosure;

FIG. 5 is a block diagram of an example phase-frequency detector system/circuit, in accordance with the present disclosure;

FIG. 6 is a block diagram of an example method of operating a synchronized Q-switched pulsed laser, in accordance with the present disclosure; and

FIG. 7 is a block diagram of an example computer system operative to perform processing, in accordance with the present disclosure.

### DETAILED DESCRIPTION

Prior to describing example embodiments of the present disclosure some information is provided. Laser ranging systems can include laser radar (ladar), light-detection and ranging (lidar), and range-finding systems, which are generic terms for the same class of instruments that use light to measure the distance to objects in a scene. This concept is similar to radar, except optical signals are used instead of radio waves. Similar to radar, a laser ranging and imaging system emits a pulse toward a particular location and measures the return echoes (reflections) to extract the range.

Laser ranging systems generally work by emitting a laser pulse and recording the time it takes for the laser pulse to travel to a target, reflect, and return to a photoreceiver, which time is commonly referred to as the “time of flight.” The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam (or, successive pulses) across a target area to measure the distance to multiple points across the field of view, producing a full three-dimensional range profile of the surroundings. More advanced flash lidar cameras, for example, contain an array of detector elements, each able to record the time of flight to objects in their field of view.

Lidar systems can use a single laser or multiple lasers to transmit pulses, and single or multiple detectors for sensing and timing the pulse returns. A lidar system's field-of-regard (FOR) is the portion of a scene that it can sense over multiple observations, whereas its field-of-view (FOV) is the portion of the scene that its detectors can sense in a single observation. Depending on type of lidar system, the FOV of its detectors may be scanned over its FOR over multiple observations (“scanned lidar”), or in a “staring” system the detector FOV may match the FOR, potentially updating the scene image with every observation. However, during a single observation, a lidar system can only sense the parts of its detector FOV that are illuminated by its laser. The area of the scene illuminated by a single laser pulse may be scanned over the detector FOV, necessitating multiple observations to image the part of the scene within that FOV, or it may be matched to the detector FOV (“flash lidar”) and either scanned along with the FOV over a larger FOR, or it may illuminate the entire FOR in a staring flash lidar system. These lidar system architectures differ with respect to how much laser energy per pulse is needed, how fast the laser must pulse, and how rapidly a three-dimensional image of a given FOR can be collected.

In scanned lidar systems, the returns collected by each detector of the sensor (each constituting a point in the FOR) are aggregated over multiple laser shots to build up a “point cloud” in three-dimensional space that maps the topography of the scene. In staring flash lidar systems a complete point cloud is collected with every laser shot. Lidar system architecture with respect to scanning versus staring detectors and scanning versus flash illumination are driven by issues such as the required angular span and resolution of the scene to be imaged, the available power and achievable pulse repetition frequency of the laser, the range over which the lidar system must be effective, and the desired image update rate, among many other factors. Often it is impractical to supply sufficient laser pulse energy per pixel to implement long-range flash lidar in a high-resolution staring system, whereas illuminating too small of a FOV limits the image update rate of high-resolution, wide-FOR scanned lidar systems. Lidar systems that match sensor FOV and laser illumination to the full extent of the FOR along one axis of the scene, such as angle-of-elevation, while scanning across the FOR along the other axis, such as azimuthal angle, provide an engineering compromise that limits required laser power while supporting very high image resolution and update rates.

When using light pulses to create images, the emitted pulse may intercept multiple objects, at different orientations, as the pulse traverses a 3D volume of space. The reflected (or echoed) laser-pulse waveform contains a temporal and amplitude imprint of the scene. By sampling the light reflections or echoes, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images.

In a discrete-return system, each recorded return corresponds, in principle, to an individual laser reflection (i.e., an echo from one particular reflecting surface, for example, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each backscattered laser pulse received by the system is digitized at a high sampling rate (e.g., 500 MHz to 1.5 GHz). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters—either obtains the range (R) to one or more targets along a single pointing angle or obtains the range and reflected pulse intensity (I) of one or more objects along a single pointing angle, resulting in the collection of pulse range-intensity data, (R, I)ᵢ, where i indicates the number of pulse returns captured for each outgoing laser pulse.

More generally, laser ranging instruments can collect ranging data over a portion of the solid angles of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the laser pulse returns (reflections), these instruments obtain a 3D data set (e.g., angle, angle, range)ₙ, where the index n is used to indicate that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set (e.g., angle, angle, (range-intensity)ₙ) is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar transmitters typically produce emissions (laser outputs) that are generally invisible to the human eye. For example, lidar systems can include different types of lasers operating at different wavelengths, including those that are not visible (e.g., wavelengths of 840 nm or 905 nm), in the near-infrared (NIR) (e.g., at wavelength of 1064 nm), and in the thermal or short wavelength infrared including wavelengths known as the “eye-safe” spectral region (generally those beyond 1400-nm, e.g., 1550 nm), where ocular damage is less likely to occur. However, when the wavelength of the laser is close to the range of sensitivity of the human eye—the “visible” spectrum, or roughly 350 nm to 730 nm, it is generally desirable, for safety reasons, to lower the energy of the laser pulse and/or the average power of the laser below certain thresholds (e.g., as recognized by certain safety standards) to avoid causing ocular damage.

Certain industry standards and/or government regulations define “eye safe” energy density or power levels for laser emissions, including those at which lidar systems typically operate. For example, industry-standard safety regulations IEC 60825-1: 2014 and/or ANSI Z136.1-2014 define maximum power levels for laser emissions to be considered “eye safe” under all conditions of normal operation (i.e., “Class 1”), including for different lidar wavelengths of operation. The power limits for eye safe use vary according to wavelength due to absorption characteristics of the structure of the human eye. For example, because the aqueous humor and lens of the human eye readily absorb energy at 1550 nm, little energy reaches the retina at that wavelength. Comparatively little energy is absorbed, however, by the aqueous humor and lens at 840 nm or 905 nm, meaning that most incident energy at that wavelength reaches and can damage the retina. Thus, a laser operating at, for example, 1550 nm, can—without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal—reflected from the distant target—is of sufficient magnitude to be detected. To determine the minimum required laser transmission power, several factors should be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specula rly reflecting objects (i.e., those objects that are not diffusively-scattering objects), the collimated laser beams can be directly reflected back, largely unattenuated. This means that—if the laser pulse is transmitted, then reflected from a target that is immediately in front of the transmitting laser, e.g., 1 meter away—it is possible that the full energy (J) from the laser pulse will be reflected into the photoreceiver; but—if the laser pulse is transmitted, then reflected from a target that is farther away, e.g., 333 meters away—it is possible that the return will have a pulse with energy approximately 10\hat{ }12 weaker than the transmitted energy. To provide an indication of the magnitude of this scale, the 12 orders of magnitude (10\hat{ }12) is roughly the equivalent of: the number of inches from the Earth to the sun, or the ratio of the luminous output from a phosphorescent watch dial, one hour in the dark, to the luminous output of the solar disk at noon.

In many cases, lidar systems utilize highly sensitive receivers (photoreceivers) to increase the system sensitivity and reduce the amount of laser pulse energy that is needed to reach (and return from) poorly reflective targets at the longest distances required, and to maintain eye-safe operation. Some variants of these detectors include those that incorporate photodiodes, and/or offer gain, such as avalanche photodiodes (APDs) or single-photon avalanche detectors (SPADs). These variants can be configured as single-element detectors, segmented-detectors, linear detector arrays, or area detector arrays. Using highly sensitive detectors such as APDs or SPADs reduces the amount of laser pulse energy required for long-distance ranging to poorly reflective targets. A technological challenge of these photodetectors is that they should also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal—changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy can reduce the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—can require emitting 120,000 pulses (20*10*60*10=120,000). When update rates of 30 frames per second are required, such as is commonly required for automotive lidar, roughly 3.6 million pulses per second must be generated and their returns captured.

There are many ways to combine and configure the elements of the lidar system—including considerations for the laser pulse energy, beam divergence, detector array size and array format (e.g., single element, linear (1D) array, or 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example, compared to the 3D lidar above, to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eye-safe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a from a closer-by object can be recorded, as well as the range and intensity of later reflection(s) of that pulse—one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects, are many orders of magnitude greater in intensity than the intensity of returns from distant targets. Many lidar systems require highly sensitive photodetectors, for example avalanche photodiodes (APDs), which along with their CMOS amplification circuits. So that distant and poorly-reflective targets may be detected, the photoreceiver components may be optimized for high conversion gain. Largely because of their high sensitivity, these detectors may be damaged by very intense laser pulse returns.

For example, if an automotive equipped with a front-end lidar system were to pull up behind another car at a stoplight, the reflection off of the license plate may be significant—perhaps 10\hat{ }12 higher than the pulse returns from targets at the distance limits of the lidar system. When a bright laser pulse is incident on the photoreceiver, the large current flow through the photodetector can damage the detector, or the large currents from the photodetector can cause the voltage to exceed the rated limits of the CMOS electronic amplification circuits, causing damage. For this reason, it is generally advisable to design the optics such that the reflections from close objects are blurred, so that a portion of the optical energy does not reach the detector or is spread between multiple detectors. However, capturing the intensity of return pulses over a larger dynamic range associated with laser ranging may be challenging because the signals are too large to capture directly. Signal intensity can be inferred (deduced) by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

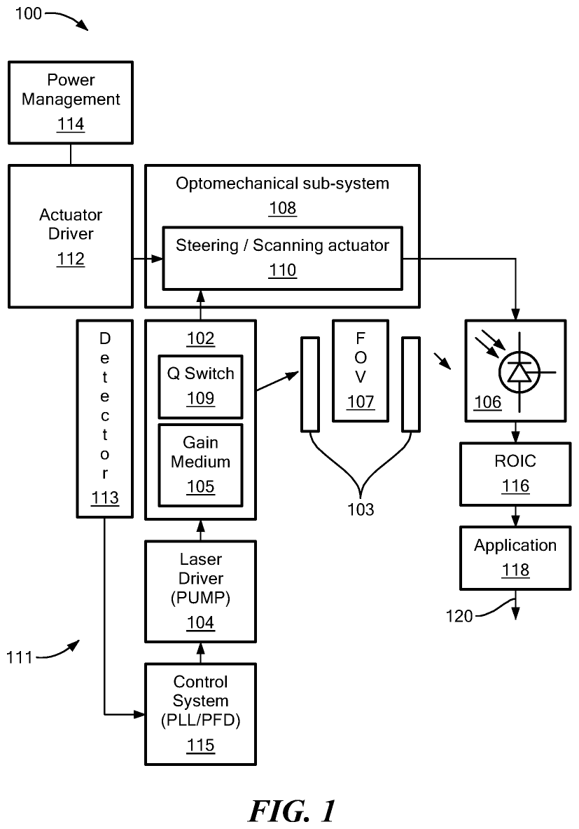

FIG. 1 is a block diagram showing major components of an example embodiment of a lidar system 100 utilizing a Q-switched laser, in accordance with the present disclosure. System 100 can include a scanned lidar system in some embodiments, a flash lidar system in other embodiments, or a hybrid (scanning/flash) system in still other embodiments. System 100 includes an illumination source 102, shown as solid state laser, operative to receive pump energy from pump (pump means) 104. Solid state laser 102 can include an optical cavity with gain medium 105 and Q-switch 109 disposed along the optical path. Appropriate pump energy may be supplied by one or more suitable energy sources or pumps (a.k.a., pump means) 104, e.g., diodes lasers. In some examples and embodiments, pump (pump means) 104 can include one or more laser diodes operative to produce pump energy at a wavelength suitable to pump (excite) the illumination source (laser) 102.

Optics 103 are shown and can be used for the illumination source 102 and/or receiver 106 (e.g., in monostatic or bistatic configurations). The illumination source (e.g., a laser or LED) 102 produces an output (e.g., one or more laser pulses). An optical receiver (e.g., detector) 106, shown as a representative photodiode, receives laser returns (reflections of the laser outputs) from objects and/or surfaces in the FOV 107. A feedback loop 111 with monitoring photodetector 113, configured to monitor the output illumination source 102, and control system 115, e.g., with phase-locked loop (PLL) and/or phase-frequency detector (PVD) can be included as shown.

The detector 106 can include an array of individual detectors, e.g., a one-dimensional array (1×N) or a two-dimensional array (M×N). A field-of-view (FOV) 107 of the detector is shown on the optical path between the laser (illumination source) 102 and the detector 106, which is directed to and “viewing” the FOV 107. Detector 106 operates to detect energy reflected from objects and/or surfaces in the FOV 107. An optomechanical subsystem 108, e.g., a steering/scanning actuator 110 for transmit beam steering, can be included to scan the illumination source 102 and detector 106 in one or more directions. Optomechanical subsystem 108, e.g., a steering/scanning actuator 110, can operate as a line scanning system in some examples or a point scanning system in other examples. An actuator driver 112 can control the movement of the actuator 110. While embodiments of system 100 can be configured as scanning lidar systems, other embodiments of system 100 can be configured as flash lidar systems not utilizing steering/scanning such that optomechanical subsystem 108 or subcomponents 110 and/or 112 may be omitted.

System 100 further includes a power management block 114, which provides and controls power to the system 100. Once received at the detector 106, the incident photons are converted by the detector 106 (e.g., photodiodes) to electrical signals, which can be read-out by the system for signal processing. A readout integrated circuit or circuitry (ROIC) 116 is shown connected to receiver (optical detector) 106 for receiving the output from the detector 106. ROIC 116 can be used for, e.g., amplification, discrimination, timing, and/or digitization. The term ROIC as used herein can include reference to a digital ROIC (DROIC) or a digital pixel ROIC (DPROIC) and embodiments of ROIC 116 can include or be configured as, e.g., a DROIC or a DPROIC. One or more additional signal processing blocks (not shown) may be used for further signal processing of the signals generated from the returns. The data can be passed to one or more systems or applications 118 for further use, e.g., for point cloud generation by an autonomous vehicle control system, etc. An output data stream 120 can include lidar range data (e.g., range/amplitude information) and/or metadata information including any detected fault(s) within the lidar sensor—including false-lock faults, as described further detail below.

An aspect of the present disclosure provides a passively Q-switched laser system that is operable to emit a pulse train that is synchronized to a reference clock operating at a relatively high pulse repetition frequency (PRF). A high PRF can be defined as the pulse period being on the order of, or less than, the excited state lifetime of the laser gain medium. Such a pulsed laser system can include a gain medium; a pump source (pump means) that excites the gain medium into a higher energy state; a passive Q-switch; a photodetector that produces an electronic signal synchronous with the laser output pulse; and an electronic control system that inputs the signal from the photodetector and controls the pump source to optimize the synchronization between the output laser pulses and a reference clock. The clock source may be internally generated by the electronic control system or input externally.

Examples and embodiments of the present disclosure can provide passively Q-switched lasers offering advantages of small size, low cost, and high peak-power, while being synchronized to a high-PRF clock source. Examples and/or embodiments of the present disclosure may support many different types of passively Q-switched lasers and/or diverse types of building blocks, provided the pump output level can be externally controlled in accordance with the present disclosure. In some examples and embodiments, passively Q-switched lasers can be utilized as transmitters in automotive LIDAR systems.

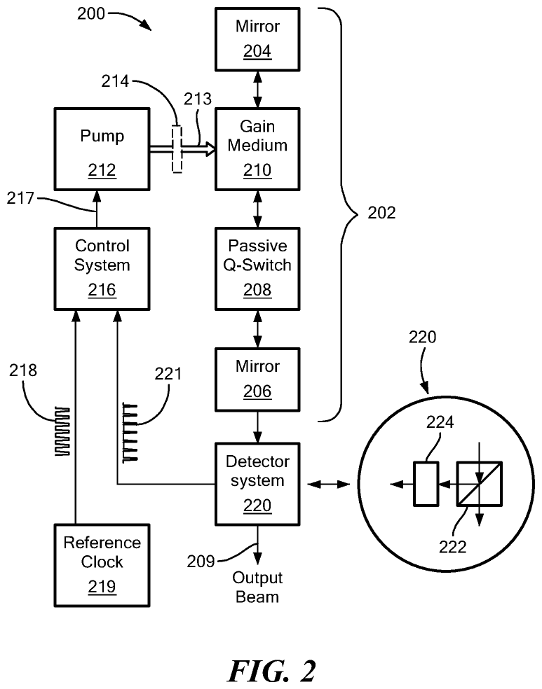

FIG. 2 is a block diagram showing major functional components of an example passively Q-switched pulsed laser system 200, in accordance with the present disclosure. Pulsed laser system 200 can include an optical cavity 202 with mirrors 204, 206, passive Q-switch (saturable absorber) 208, and gain medium 210. A pump/pump means 212 can supply suitable energy to energize gain medium 210, e.g., using coupling optic 214. The energy flowing into gain medium 210 is shown as wide arrow 1 in the figure. While two mirrors 204, 206 are shown for cavity 202, other examples/embodiments of Q-switched pulsed laser system 200 may include more than two cavity mirrors, e.g., multiple cavity mirrors forming a ring cavity or a linear cavity.

It should be understood that while a particular order is shown for the laser optical components, other orderings of components are also within the scope of the present disclosure, e.g., the Q-switch 208 may be on either side of the gain medium 210 and the detector may be on the inside of the cavity. Similarly, the laser 200 may have other building blocks not shown. Also, it will be understood that the coupling optics may be configured to cause the pump energy to flow in the same direction as the optical axis of the cavity (longitudinal pumping) or perpendicular to the optical axis of the cavity (side pumping).

Detector system 220, acting as a monitoring detector, can be configured to detect the optical output (e.g., pulse train) from optical cavity 202 and provide a corresponding electrical signal 221 to control system 216. Control system 216 also receives a clock signal 218 from a reference clock 219. The power level of the pump 212 can be controlled by an electrical (control) signal generated by control system 216.

Gain medium 210 can be composed of or include any suitable laser gain (active) medium. For example, gain medium 210 can include a crystal or glass matrix doped with rare earth ions. Some examples can include erbium-ytterbium-doped yttrium aluminum borate (Er, Yb:YAB), neodymium doped yttrium aluminum garnet (Nd:YAG), erbium-ytterbium-doped yttrium aluminum garnet (Er,Yb:YAG), erbium doped glass, and/or erbium-doped yttrium aluminum garnet (Er:YAG). Some examples can include neodymium-doped vanadate crystals, e.g., yttrium vanadate (Nd:YVO₄), gadolinium vanadate (Nd:GdVO₄), and/or lutetium vanadate (Nd:LuVO₄). Some examples can include Nd:GYSGG. Of course, while some examples have been given that include crystal or glass doped with rare earth ions, other suitable gain media can be used within the scope of the present disclosure; examples can include crystal or glass matric doped with non-rare-earth ions (e.g., Cr:LiCAF, Cr:LiSAF, etc.), any suitable semiconductor laser media (e.g., InGaAs, GaAs, etc.), or even suitable gas (e.g., carbon dioxide, helium-neon, argon, krypton, and excimer, etc.) or liquid (e.g., dye) gain media.

Passive Q-switch (saturable absorber) 208 can include any suitable saturable absorber (SA) material. In some examples, saturable absorber 208 can include chromium-doped yttrium-aluminum-garnet (Cr₄₊:YAG), cobalt-doped spinel (Co2+:MgAl₂O₄), or three-valence (vanadate)-doped yttrium-aluminum-garnet (V₃₊:YAG). Other saturable absorber materials that can be used include, but are not limited to, graphene, graphene oxide, and semiconductor saturable absorbing mirrors (SESAMs).

The output pulse train of the Q-switched laser 200 is detected by the detector system 220, which converts a portion of the optical pulse train to an electrical signal 221 that is shown in the figure along the connector between the detector 220 and the control system 216. The detector system 220 can include one of many photodetector devices that detect the wavelength of light output by the laser and preferably has a rise time significantly shorter than the period of the output pulse train. Some examples of suitable detectors include PIN or APD photodiodes. Some examples of suitable detector material types are semiconductors such as silicon and germanium, or compound semiconductors (semiconductor alloys) such as InGaAs and GaAs, etc.

Reference clock 219 is the master timing source for the system 200. Reference clock 219 may be internal to the system 200 or provided externally. In some examples, reference clock signal 218 is a periodic electronic signal that will be used by the system 200 to set (control or synchronize) the output pulse timing. In some examples, the output optical pulses will either be synchronized with the reference clock signal, or the emission of output optical pulses will occur at a set time after the peaks of the reference clock signal.

Control system 216 is an electronic subsystem that inputs the reference clock signal 218 and the electronic output 221 of the detector system 220. The output 217 of control system 216 is the pump control signal that determines the timing and the level of the pump power. Control system 216 determines the pump control signal 217 in a way to optimize the synchronization between the reference clock signal 218 and the detector output 221. Control system 216 may be composed of or include digital and/or analog circuitry including but not limited to microcontrollers, microprocessors, field programmable gate arrays, digital signal processors (DSP), phase-frequency detectors (PFD), analog-to-digital converters (ADCs), and/or or digital-to-analog converters (DACs), etc.

Control system 216 can be configured to perform three primary functions: (1) sensing the input signals from the reference clock and detector, (2) determining the optimal pump level setting given the input signals, and (3) setting the pump control signal to the optimal value for synchronizing the laser PRF to the clock signal. The sense function can be accomplished by a variety of means or techniques, e.g., generating an error signal with a phase-frequency detector or sampling the two input signals to generate arrival time sequences. The determination of the optimal pump level can be accomplished through, e.g., a simple PID loop such as a phase-locked loop or using more sophisticated control methods, e.g., utilizing feed-forward, fuzzy logic, and/or machine learning.

An example embodiment of control system 216 can utilize/implement both feed-forward logic and machine learning (ML). The control system 216 can include a digital algorithm (e.g., implemented via software application or computer-readable code) with inputs of the arrival times of the last N pulses and determine the optimal pump level setting (or a pump level time series) using a feedback function that is adjustable by the algorithm. The algorithm can then determine how well the feedback function performed by calculating a merit function from the next N pulses. The feedback function can be optimized in this way and may change to stay optimized over time.

The setting of the pump control signal 217 by control system 216 may be as simple as setting the DC power level of the pump 212, thus adjusting its PRF and output phase. However, control system 216 can include more complicated control means (e.g., circuitry and/or control logic implemented by computer-readable instructions), which may be advantageous for some applications. For example, pump 212 may be driven with a modulated signal that has the same frequency and is phase-locked to the reference clock signal 218. In such a case, there are several quantities the control system 216 can set: duty cycle of control (pump drive) signal 217 provided to drive pump 212, DC offset of the control signal 217, modulation depth of the control signal 217 (amplitude difference between high and low values), or peak amplitude of pump drive signal.

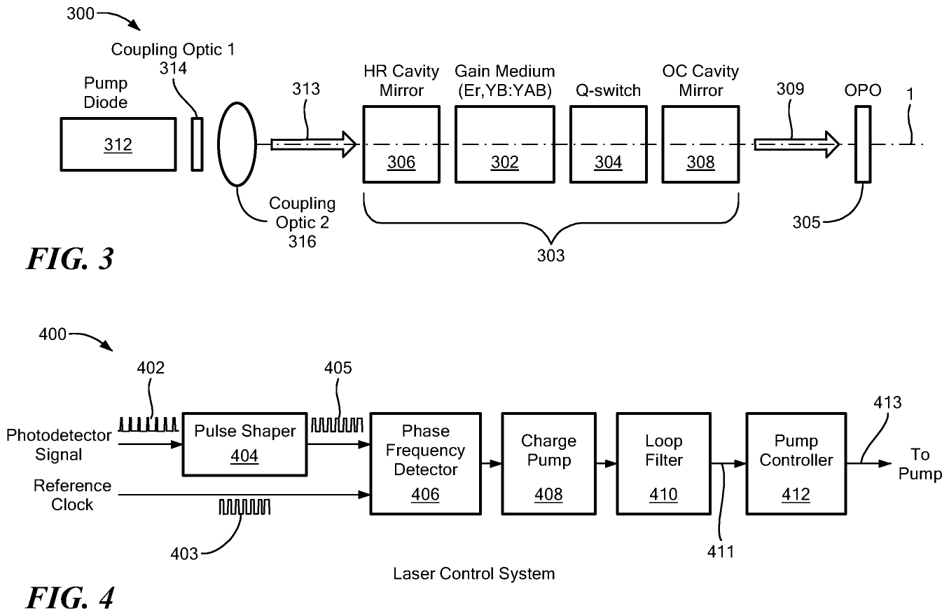

FIG. 3 shows an example passively Q-switched diode-pumped solid state laser system 300, in accordance with the present disclosure. Laser system (laser) 300 can include optical cavity (resonator) 303 having include first and second mirrors on either side of gain medium 302 and saturable absorber 304 configured as a passive Q-switch. Pump (pump means) 312 for supplying pump energy to gain medium 302 is shown. Optical output (pulse train) 309 is shown emanating from cavity 303 along optical axis 1. Optional optical parametric oscillator (OPO) 305 is shown and may be present to shift the optical output 309 to a desired wavelength. Any suitable OPO and/or optical parametric amplifier (OPA) material may be used for element 305. The OPO or (OPA) may be outside of the optical cavity 303 as shown in FIG. 3; or, in alternate examples/embodiments, the OPO/OPA may operate intracavity by being inside the cavity 303 in order to increase the efficiency of the OPO operations.

In some examples, laser 300 can nominally emit a pulse train of 10 μJ pulses with 5 ns pulse width, a PRF of 100 kHz, and wavelength nominally at 1522 nm. In some examples, pump (pump means) 312 can include a laser diode that emits up to 10 W of continuous optical power at a nominal wavelength of 976 nm. In an example, pump diode 312 and two coupling optics (fast axis optic 1 and slow axis optic 2) can form a beam with a focal spot in, e.g., the first half of the gain medium 302, with a nominal 1/e² diameter of 100 μm (micron).

High-reflectivity (HR) cavity mirror 306 is shown as the high reflector of the cavity 303. A first surface of the HR mirror 306 (shown as surface closest to pump diode) can be anti-reflective (AR) coated at both the pump (e.g., 976 nm) and the laser (e.g., 1522 nm) wavelengths. The second surface of HR mirror 306 can be anti-reflective coated at the pump wavelength and highly-reflective coated at the laser wavelength (e.g., R>99%). Output coupler mirror (OC cavity mirror) 308 is shown as the second mirror that makes up the optical cavity 303. A first surface (shown as surface closest to gain medium 302) of the OC cavity mirror 308 can have a reflectivity of, e.g., 98%, at the laser wavelength and the second surface can be anti-reflective coated at the laser wavelength.

In some examples, the optical surfaces on the mirrors can be flat and have a nominal size of 2 mm×2 mm×2 mm. In some examples, the reflective sides of the mirrors can be separated by 6 mm. In some examples, the gain medium 302 can include a 1.5 mm long piece of c-cut YAI₃(BO₃)₄ crystal (commonly called YAB) that is doped with Er³⁺ with an atomic concentration of 1.5% and doped with Yb³⁺ with an atomic concentration of 12%. The YAB crystal can be AR coated on both sides and can have a nominal size of 1.5 mm×2 mm×2 mm. In some examples, the Q-switch 304 can include a 1 mm long piece of c-cut MgAl₂O₄ crystal (commonly called spinel) that is doped with Co²⁺ such that the unsaturated transmission at the laser wavelength is 98%. The Q-switch crystal can be AR coated on both sides and can have a nominal size of 1.0 mm×2 mm×2 mm. Of course, while certain dimensions have been description for some examples, other dimensions may be used within the scope of the present disclosure.

In some examples, the output of the laser 300 can be a beam with 100 mm nominal diameter (1/e\hat{ }2). A small fraction of the beam can be split off by passing the beam through a beam-splitting optic (e.g., shown as 222 in FIG. 2) that transmits a portion (e.g., approximately 1%) of the output beam to the (monitoring) detector (e.g., 224 in FIG. 2). In some examples, the monitoring detector can include an indium-gallium-arsenide (InGaAs) PIN photodiode with diameter of 0.3 mm and negatively biased at 3.3 V.

FIG. 4 is a block diagram of an example laser control system/circuit 400, in accordance with the present disclosure. The photodetector signal can be fed into the laser control system as shown in FIG. 4. The laser control system/circuit (a.k.a., control circuitry) 400 can include a pulse shaping subsystem (pulse shaper) 404 that receives the pulses 402 from the photodetector (e.g., detector system 220 in FIG. 2) and broadens them out. The broadened timing signals 405 can then be compared to the reference clock signal 403, e.g., in a phase frequency detector 406, in order to generate an error signal 411 to supply to the pump controller 412. Control system/circuit 400 can include a charge pump 408 configured to receive the output from phase frequency detector 406. Loop filter 410 can receive an output from charge 408. Pump controller 412 is configured to receive error signal 411, as supplied from loop filter 410, and output a control signal 413 for controlling the pump source (pump means). The control signal 413 can be characterized by a frequency, a phase, a duty-cycle, and a DC value. In some examples, the frequency of the control signal can be nominally equal to the desired laser PRF of the pump source, e.g., diode laser, in some examples.

In some examples, laser control system/circuit 400 can include a switching power supply where the switching frequency of the power supply modulates the (pump drive) control signal provided to the pump source. This configuration may be advantageous for higher PRF ranges/values, e.g., 200 kHz to 500+kHz. In this method the average (pump drive) control signal current can be adjusted to set the PRF and phase of the output pulse train.

In some examples, laser control system/circuit 400 can include a power supply with a power output that can be modulated with the modulation of the control voltage of the power supply determining the frequency, phase, duty cycle, and DC value of the pump drive signal (e.g., current. This configuration may be advantageously used for lower PRF ranges/values, e.g., (50 kHz to 200 kHz).

As shown in FIG. 4, pump controller 412 can provide a DC current to the pump source, e.g., laser diode 312 shown in FIG. 3. The error signal 411 can be used by pump controller 412 to either increase or decrease the pump current provided to the pump diode (e.g., 312 in FIG. 3) completing the feedback loop that controls the phase and frequency of the output pulse train of the pulse laser (e.g., laser 300).

In alternative embodiments, the pump controller 412 can provide a drive current that is modulated with, e.g., the same phase and frequency as the reference clock signals 403. In this case, the error signal 411 may be used by the pump controller 412 to increase/decrease the peak current, the duty cycle, or a DC offset term on the modulated output of the pump source (e.g., laser diode 312 in FIG. 3).

In some examples, the power supply for the laser pump diode may be a switch mode voltage source using feedback from the current supplied to the pump diode. An increase of the pump diode current functions to increase the pulse repetition frequency (PRF) of the laser. Where the PRF is much lower than the switching frequency of the power supply, the output current of the power supply may be modulated by modulating the power supply control input. In other examples, if the PRF of the laser is made equal to the switching frequency of the power supply, then the power supply output filter may be reduced so that there is significant current ripple at the switching frequency. This mode can require that the power supply oscillator be triggered from an oscillator providing the reference frequency.

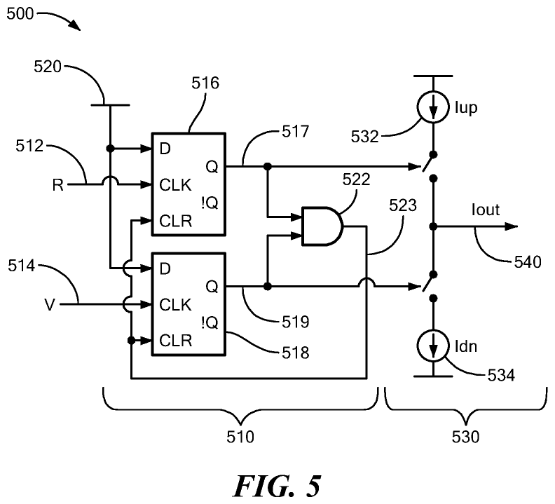

FIG. 5 is a block diagram of an example phase-frequency detector system/circuit 500, in accordance with the present disclosure. Phase frequency detector 500 can include two flip-flops (latches) 516, 518 and a feedback reset through an AND gate 552. Flip-flops 516 and 518 are configured to receive reference (clock) signals 512 and photodetector signals 514 (from monitoring detector), respectively. Phase frequency detector 500 is shown followed by charge pump 530, which includes UP and DOWN current sources 532 and 534. In some examples, phase frequency detector 500 may also be combined with a loop filter, e.g., suitable R-C network (not shown). Flip-flops 516 and 518 are configured, in conjunction with AND gate 552, to produce UP and DOWN commands, respectively, to UP and DOWN current sources 532 and 534 of charge pump 530. Phase frequency detector 500 measures the phase and frequency difference(s) between the reference (clock) signals 512 and photodetector signals 514 and produces an error signal 540. Error signal 540 generated by the phase-frequency detector/charge pump/loop filter blocks can be supplied to pump controller (e.g., shown in FIG. 4 as 412). While D-type flip-flops are shown in the drawing, other types of flip-flops may be used, with appropriate connections.

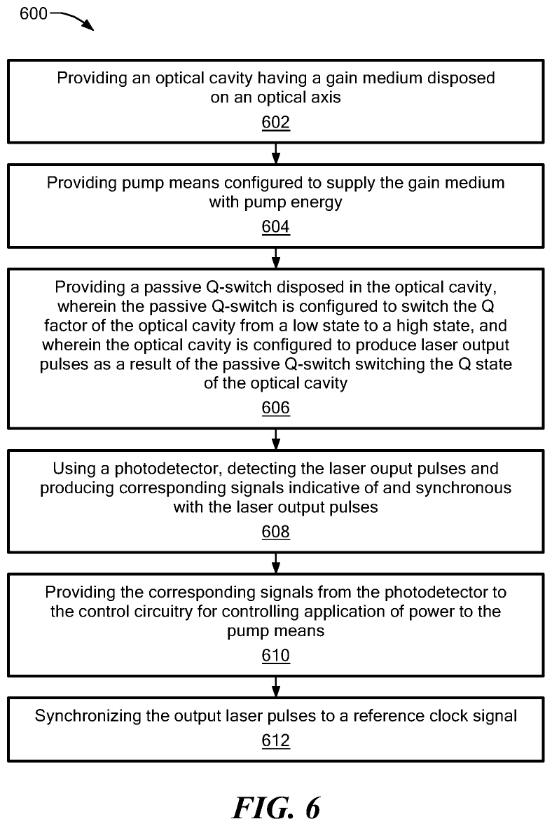

FIG. 6 is a block diagram of an example method 600 of operating a synchronized Q-switched pulsed laser, in accordance with the present disclosure. For method 600, an optical cavity can be provided having a gain medium disposed on an optical axis, as described at 602. Method 600 can include providing pump means configured to supply the gain medium with pump energy, as described at 604. A passive Q-switch can be provided that is disposed in the optical cavity on the optical axis, wherein the passive Q-switch is configured to switch the Q factor of the optical cavity from a low state to a high state, and wherein the optical cavity is configured to produce laser output pulses as a result of the passive Q-switch switching the Q state of the optical cavity, as described at 606. A photodetector can be used to detect the laser output pulses, producing corresponding signals indicative of and synchronous with the laser output pulses, as described at 608. Corresponding signals from the photodetector can be provided to the control circuitry for controlling application of power to the pump means (pump source), as described at 610. The output laser pulses can accordingly be synchronized to a reference clock signal, as described at 612. Method 600 can be used to synchronize a pulse laser output to a reference clock signal at a high PRF, where, as noted above, a high PRF can be defined as the pulse period being on the order of, or less than, the excited state lifetime of the laser gain medium.

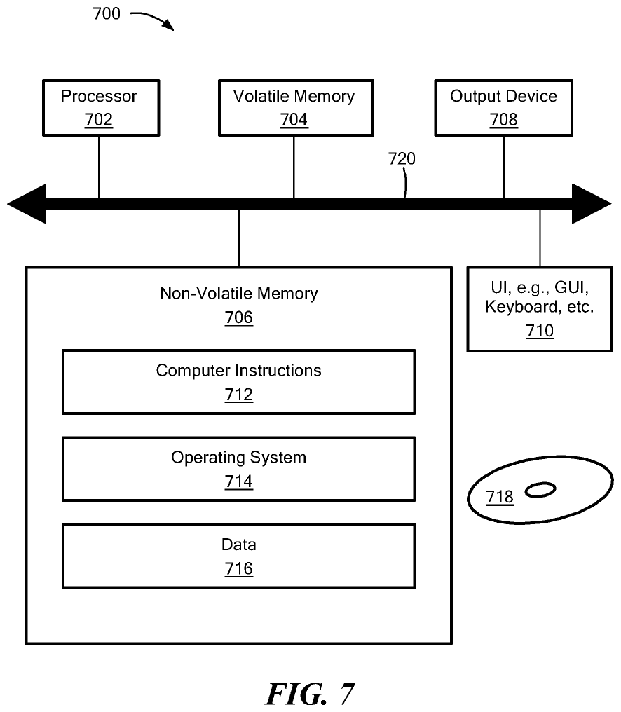

FIG. 7 is a block diagram of an example computer system 700 operative to perform processing, in accordance with the present disclosure. Computer system 700 can perform all or at least a portion of the processing, e.g., steps in the algorithms and methods, described herein. The computer system 700 includes a processor 702, a volatile memory 704, a non-volatile memory 706 (e.g., hard disk), an output device 708 and a user input or interface (UI) 710, e.g., graphical user interface (GUI), a mouse, a keyboard, a display, and/or any common user interface, etc. The non-volatile memory (non-transitory storage medium) 706 stores computer instructions 712 (a.k.a., machine-readable instructions, computer-readable instructions, or code) such as software (computer program product, or one or more software applications), an operating system 714 and data 716. In one example, the computer instructions 712 are executed by the processor 702 out of (from) volatile memory 704. In one embodiment, an article 718 (e.g., a storage device or medium such as a hard disk, an optical disc, magnetic storage tape, optical storage tape, flash drive, etc.) includes or stores the non-transitory computer-readable instructions. Bus 720 is also shown.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 700 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. Further, the terms “computer” or “computer system” may include reference to plural like terms, unless expressly stated otherwise.

Processing may be performed by one or more programmable processors executing one or more computer programs to perform the functions of the system. All or part of the system may be implemented as, special purpose logic circuitry, e.g., an FPGA (field programmable gate array) and/or an ASIC (application-specific integrated circuit).

Accordingly, embodiments of the inventive subject matter can afford various benefits relative to prior art techniques. Embodiments of the present disclosure can provide for synchronization of pulse trains from a pulsed lasers at high PRF. Moreover, example embodiments of the present disclosure can enable, facilitate, or provide lidar systems and components achieving or obtaining an Application Safety Integration Level (ASIL) in accordance with a safety standard such as ISO 26262.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while description of embodiments of the present disclosure has been in the context of diode-pumped solid state laser, other examples and/or embodiments of the present disclosure can provide pulsed lasers with different gain media (e.g., gas, liquid dye, diode) and/or different pump means (e.g., flash lamps, electric current, etc.).

It is noted that various connections and positional relationships (e.g., over, below, adjacent, etc.) may be used to describe elements in the description and drawing. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising, “include,” “includes,” “including,” “has,” “having,” “contains” or “containing,” or any other variation are intended to cover a non-exclusive inclusion. For example, an apparatus, a method, a composition, a mixture, or an article, that includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc. The term “plurality” indicates any integer number greater than one. The term “connection” can include an indirect “connection” and a direct “connection.”

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A passive Q-switched synchronous laser system comprising:
a. an optical cavity having an optical axis;
b. a gain medium disposed in the optical cavity along the optical axis;
c. pump means configured to supply the gain medium with pump energy;
d. a passive Q-switch disposed in the optical cavity along the optical axis, wherein the passive Q-switch switches the Q factor of the optical cavity from a low state to a high state, and wherein the optical cavity produces laser output pulses as a result of the passive Q-switch switching the Q state of the optical cavity;
e. a photodetector configured to detect the laser output pulses and to produce corresponding signals indicative of and synchronous with the laser output pulses; and
f. control circuitry configured to receive the signals from the photodetector and control application of power to the pump means to synchronize the output laser pulses to a reference clock signal.

2. The laser system of claim 1, wherein the passive Q-switch is configured to produce the laser output pulses as an output pulse train having a pulse repetition frequency (PRF).

3. The laser system of claim 2, wherein the control circuitry comprises a feedback loop with an error signal based on the frequency and phase difference between the output pulse train and the reference clock signal.

4. The laser system of claim 1, wherein the passive Q-switch comprises a saturable absorber.

5. The laser system of claim 4, wherein the saturable absorber comprises chromium-doped yttrium-aluminum-garnet (Cr₄+:YAG).

6. The laser system of claim 4, wherein the saturable absorber comprises cobalt-doped spinel (Co2+:MgAl₂O₄).

7. The laser system of claim 4, wherein the saturable absorber comprises vanadate-doped yttrium-aluminum-garnet (V₃+:YAG).

8. The laser system of claim 1, further comprising an optical parametric oscillator (OPO) disposed in the optical cavity along the optical axis, wherein the OPO is configured to shift the laser output in wavelength.

9. The laser system of claim 1, wherein the gain medium comprises a crystal or glass matrix doped with rare earth ions.

10. The laser system of claim 1, wherein the laser is operative to produce laser output pulses having a wavelength of between about 800 nm and about 1800 nm.

11. The laser system of claim 10, wherein the laser output pulses have a wavelength of between about 900 nm to about 910 nm.

12. The laser system of claim 10, wherein the laser output pulses have a wavelength of between about 1300 nm to about 1700 nm.

13. The laser system of claim 12, wherein the laser output pulses have a wavelength of between about 1500 nm and about 1650 nm.

14. The laser system of claim 13, wherein the laser output pulses have a wavelength of between about 1515 nm and 1560 nm.

15. The laser system of claim 14, wherein the laser output pulses have a wavelength of about 1522 nm.

16. The laser system of claim 10, wherein the laser output pulses have a wavelength of about 1064 nm.

17. The laser system of claim 8, wherein the active medium comprises erbium-ytterbium-doped yttrium aluminum borate (Er, Yb:YAB).

18. The laser system of claim 8, wherein the active medium comprises neodymium doped yttrium Vanadate (Nd:YVO₄).

19. The laser system of claim 8, wherein the active medium comprises neodymium doped yttrium aluminum garnet (Nd:YAG).

20. The laser system of claim 8, wherein the active medium comprises erbium-ytterbium-doped yttrium aluminum garnet (Er:YAG).

21. The laser system of claim 8, wherein the active medium comprises erbium-ytterbium-doped yttrium aluminum garnet (Er, Yb:YAG).

22. The laser system of claim 10, wherein the laser output pulses have a PRF of about 10 kHz to about 500 kHz.

23. The laser system of claim 14, wherein the laser output pulses have a PRF of about 200 kHz to about 500 kHz.

24. The laser system of claim 1, wherein the pump means comprises one or more laser diodes.

25. The laser system of claim 16, wherein the one or more laser diodes comprise one or more laser diodes configured to produce an output having a wavelength of about 970 nm to about 980 nm.

26. The laser system of claim 1, wherein the control circuitry is configured to produce a controlled signal to the pump that is characterized by a frequency nominally equal to the desired laser PRF of the pump laser, a phase, a duty-cycle, and a DC value.

27. The laser system of claim 1, wherein the control circuitry comprises a switching power supply where the switching frequency of the power supply modulates the pump drive.

28. The laser system of claim 1, wherein the control circuitry comprises a power supply where modulation of the control voltage of the power supply determines the frequency, phase, duty cycle, and DC value of the pump drive current.

29. An illumination system for scanned lidar, the system comprising:
a. a laser system operative to produce a laser output, the laser system comprising;
i. an optical cavity having an optical axis;
ii. a gain medium disposed in the optical cavity along the optical axis;
iii. pump means configured to supply the gain medium with pump energy;
iv. a passive Q-switch disposed in the optical cavity, wherein the passive Q-switch is configured to absorb optical energy received from the gain medium up to a threshold and then to transmit the optical energy once the threshold has been exceeded, wherein the passive Q-switch switches the Q factor of the optical cavity from a low state to a high state, and wherein the optical cavity produces laser output pulses as a result of the passive Q-switch switching the Q state of the optical cavity;
v. a photodetector configured to detect the laser output pulses and to produce corresponding signals indicative of and synchronous with the laser output pulses; and
vi. control circuitry configured to receive the signals from the photodetector and control application of power to the pump means to synchronize the output laser pulses to a reference clock signal;
b. an optic operative to receive the laser output pulses and produce a beam output having an angular spread in a first direction; and
c. a scanning system operative to scan the beam output across a desired angular span in a direction substantially orthogonal to the first direction.

30. The illumination system of claim 29, wherein the passive Q-switch is configured to produce the laser output pulses as an output pulse train having a pulse repetition frequency (PRF).

31. The illumination system of claim 29, wherein the control circuitry comprises a feedback loop with an error signal dependent on the frequency and phase difference between the output pulse train and the reference signal.

32. The illumination system of claim 29, wherein the passive Q-switch comprises a saturable absorber.

33. The illumination system of claim 32, wherein the saturable absorber comprises chromium-doped yttrium-aluminum-garnet (Cr₄+:YAG).

34. The illumination system of claim 32, wherein the saturable absorber comprises cobalt-doped spinel (Co2+:MgAl₂O₄).

35. The illumination system of claim 32, wherein the saturable absorber comprises vanadium-doped yttrium-aluminum-garnet (V3+:YAG).

36. The illumination system of claim 29, wherein the active medium comprises a crystal or glass matrix doped with rare earth ions.

37. The illumination system of claim 29, wherein the laser is operative to produce laser output pulses having a wavelength of between about 800 nm and about 1800 nm.

38. The illumination system of claim 29, wherein the laser output pulses have a wavelength of between about 1300 nm and about 1650 nm.

39. The illumination system of claim 38, wherein the laser output pulses have a wavelength of between about 1515 nm and 1560 nm.

40. The illumination system of claim 36, wherein the active medium comprises erbium-ytterbium-doped yttrium aluminum borate (Er, Yb:YAB).

41. The illumination system of claim 29, wherein the laser output pulses have a PRF of about 50 kHz to about 500 kHz.

42. The illumination system of claim 29, wherein the scanning system comprises a line scan system.

43. The illumination system of claim 29, wherein the scanning system comprises a point scan system.

44. A method of controlling a Q-switched laser, the method comprising:
a. providing an optical cavity having a gain medium disposed on an optical axis;
b. providing pump means configured to supply the gain medium with pump energy;
c. providing a passive Q-switch disposed in the optical cavity, wherein the passive Q-switch is configured to switch the Q factor of the optical cavity from a low state to a high state, and wherein the optical cavity is configured to produce laser output pulses configured as an output pulse train having a pulse repetition frequency (PRF) as a result of the passive Q-switch switching the Q state of the optical cavity;
d. using a photodetector, detecting the laser output pulses and producing corresponding signals indicative of and synchronous with the laser output pulses;
e. providing the corresponding signals from the photodetector to the control circuitry for controlling application of power to the pump means;
f. using the control circuitry, providing a control signal to the pump means to adjust the pump energy supplied to the gain medium; and
g. synchronizing the output laser pulses to a reference clock signal.

45. The method of claim 44, further comprising providing the control circuitry with an error signal based on the frequency and phase difference between the output pulse train and the reference clock signal.

46. The method of claim 44, wherein the laser output pulses have a PRF of about 50 kHz to about 500 kHz.

47. The method of claim 44, wherein the control signal has a frequency nominally equal to the PRF.
